(19) United States
(12) Patent Application Publication
(10) Pub. No.: US 2013/0255929 A1
(43) Pub. Date: Oct. 3, 2013

(54) HEAT DISSIPATION DEVICE

(71) Applicants: QIAO-LONG CHEN, Foshan City (CN); ZI-FU YANG, Foshan City (CN); MENG FU, Foshan City (CN); CHUN-CHI CHEN, Tu-Cheng (TW)

(72) Inventors: QIAO-LONG CHEN, Foshan City (CN); ZI-FU YANG, Foshan City (CN); MENG FU, Foshan City (CN); CHUN-CHI CHEN, Tu-Cheng (TW)

(73) Assignees: FOXCONN TECHNOLOGY CO., LTD., Tu-Cheng (TW); CHAMP TECH OPTICAL (FOSHAN) CORPORATION, Foshan (CN)

(21) Appl. No.: 13/586,902

(22) Filed: Aug. 16, 2012

(30) Foreign Application Priority Data
Apr. 3, 2012 (CN) 201210095717.X

(51) Int. Cl. F28F 7/00; B23P 15/26

(52) U.S. Cl. 165/185; 29/890.03

(57) ABSTRACT

A heat dissipation device includes a base and a plurality of fins. Two latch parts project from a top surface of the base, the two latch parts cooperatively define a recess therebetween. Each fin defines a tenon at a bottom portion. The tenon has a configuration in complement with that of the recess. The latch parts located between two neighboring fins is punched to make the fins fix on the base.

### BACKGROUND

1. Technical Field

The disclosure relates to a heat dissipation device.

2. Description of Related Art

A heat dissipation device is often applied to dissipate heat from heat generating components, such as central procession units (CPUs).

Conventionally, a heat dissipation device includes a plurality of fins made of aluminum and formed by extrusion type, a substrate arranged under the fins, and a heat pipe arranged on the substrate and connected to the fins and the heat pipe. The fins are soldered to the substrate and the heat pipe via stannum. The heat dissipation efficiency of the heat dissipation device is reduced since the thermal resistance of the stannum between the fins and the substrate. Further, the fins need a soldering process to fix on the substrate and the manufacture of the heat dissipation device is costly.

Thus, it is desired to overcome the described limitations.

### BRIEF DESCRIPTION OF THE DRAWINGS

FIG. 1 is an assembled view of a heat dissipation device, according to an exemplary embodiment of the present disclosure.

FIG. 2 is an inverted view of the heat dissipation device of FIG. 1.

FIG. 3 is an exploded, isometric view of the heat dissipation device of FIG. 1.

FIG. 4 is a front elevational view of a base of the heat dissipation device of FIG. 1.

FIG. 5 is a front elevational view of a fin of the heat dissipation device of FIG. 1.

FIG. 6 is a cross-sectional view of the heat dissipation device of FIG. 1, taken along line VI-VI thereof.

FIG. 7 is a cross-sectional view of the heat dissipation device after punching a latch part of the base.

### DETAILED DESCRIPTION

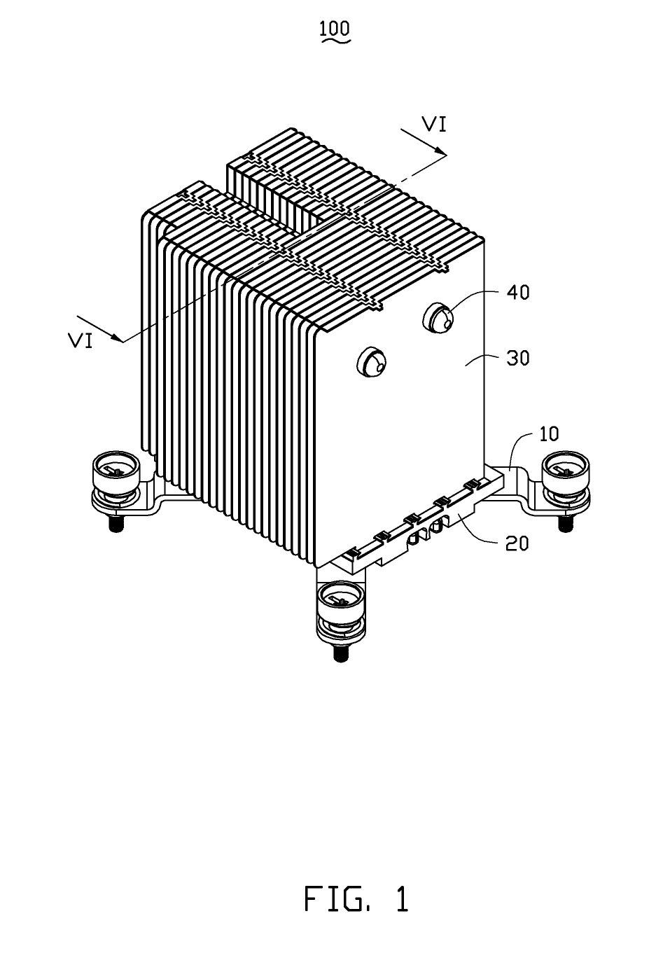

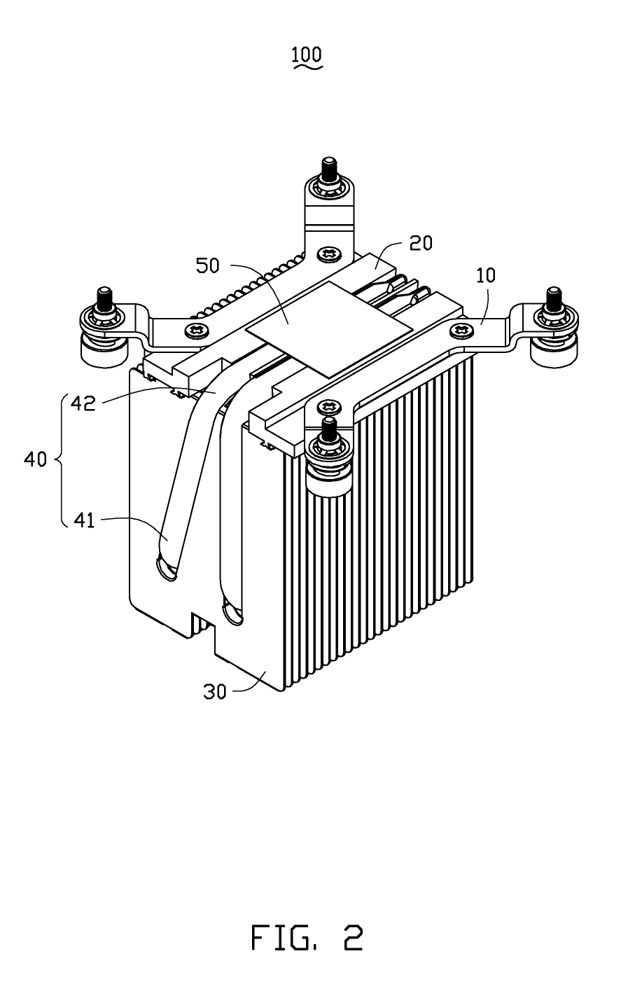

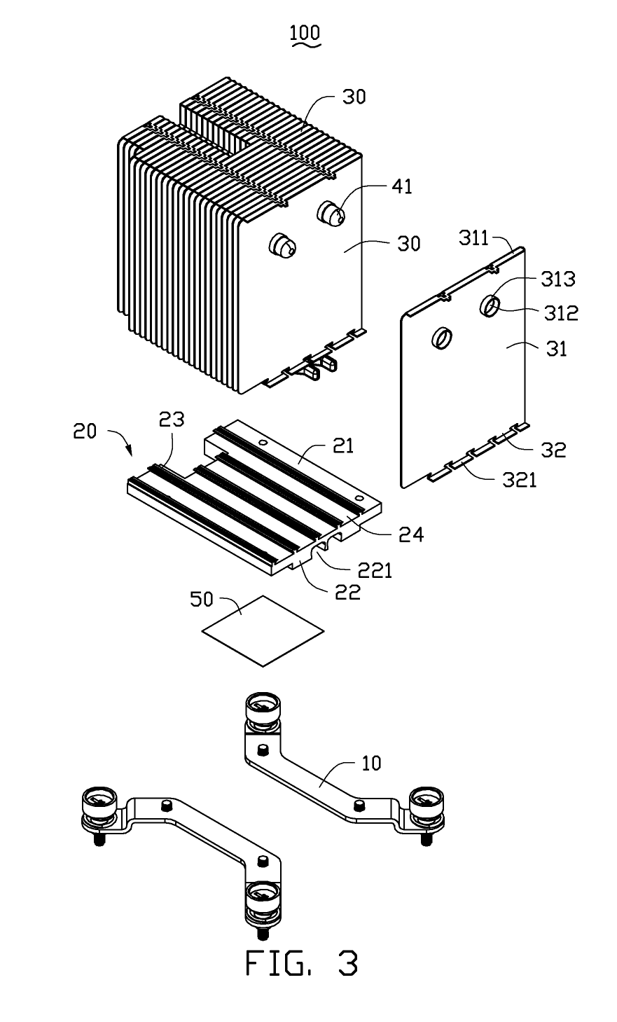

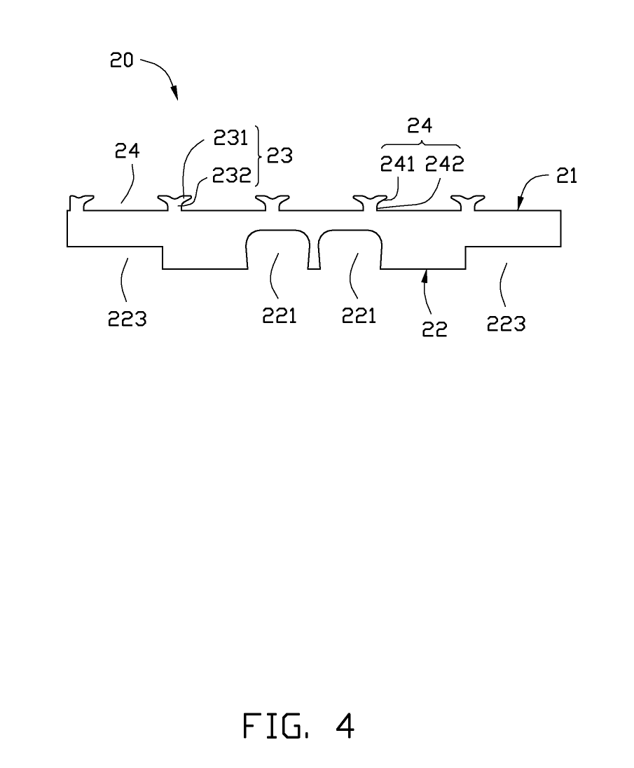

FIGS. 1, 2, 3 and 4 show a heat dissipation device 100 in accordance with an exemplary embodiment. The heat dissipation device 100 includes a holder 10, a base 20, a fin set 30 and two U-shaped heat pipes 40 connected to the base 20 and the fin set 30.

The holder 10 is engaged with the base 20 to fix the base 20, the fin set 30 and the heat pipes 40 for dissipating heat generated from electronic elements.

The base 20 has a rectangle shape, and can be made of metal with high thermal conductivity selected from a group consisting of copper, aluminum and combination thereof. The base 20 includes a top surface 21 and a bottom surface 22 opposite to the top surface 21. A plurality of latch part 23 project from the top surface 21 of the base 20 and extend along a lengthwise direction of the base 20. Each latch part 23 includes a latch portion 231 and a supporting portion 232 connected to the latch portion 231 and the top surface 21 of the base 20. In the present embodiment, a cross section view of the latch part 23 is a substantial Y-shape, and a cross section view of the latch portion 231 is a substantial V-shape. The latch part 23 is integrally formed with the base 20 as a single piece and formed by extrusion type. Height of the latch portion 231 is larger than that of the supporting portion 232. A recess 24 is defined between every two neighboring latch parts 23. Each recess 24 includes a clasp recess 241 arranged between two neighboring latch portions 231 and a connecting recess 242 arranged between the two corresponding supporting portions 232. In the present embodiment, a cross section of the clasp recess 241 is substantially wedged. A cross section of the connecting recess 242 is rectangle-shaped. A width of the connecting recess 242 is equal to a width of a largest portion of the clasp recess 241. It can be understood that the latch part 23 can only include the latch portion 231, a cross section of the latch portion 231 is a substantial V-shape, and bottom portion of the latch portion 231 engages with the top surface 21 of the base.

Two grooves 221 are defined in the bottom surface 22 of the base 20. The grooves 221 extend along the lengthwise direction of the base 20. The two grooves 221 are respectively used to receive evaporation sections 42 of the two heat pipes 40. In the present embodiment, each evaporation section 42 of the heat pipe 40 has an interference fit with the corresponding groove 221 to fix the heat pipe 40 on the base 20. A bottom surface (not labeled) of the heat pipe 40 is coplanar with the bottom surface 22 of the base 20, and the bottom surface of the heat pipe 40 has a thermally conductive relationship with an electronic element via a heat conductor substrate 50. Two elongated cutouts 223 are defined in the bottom surface 22 of the base 20. The cutouts 223 are located at two opposite sides of the base 20 respectively, and extend along the lengthwise direction of the base 20. The cutouts 223 are used for engagingly receiving the holder 10.

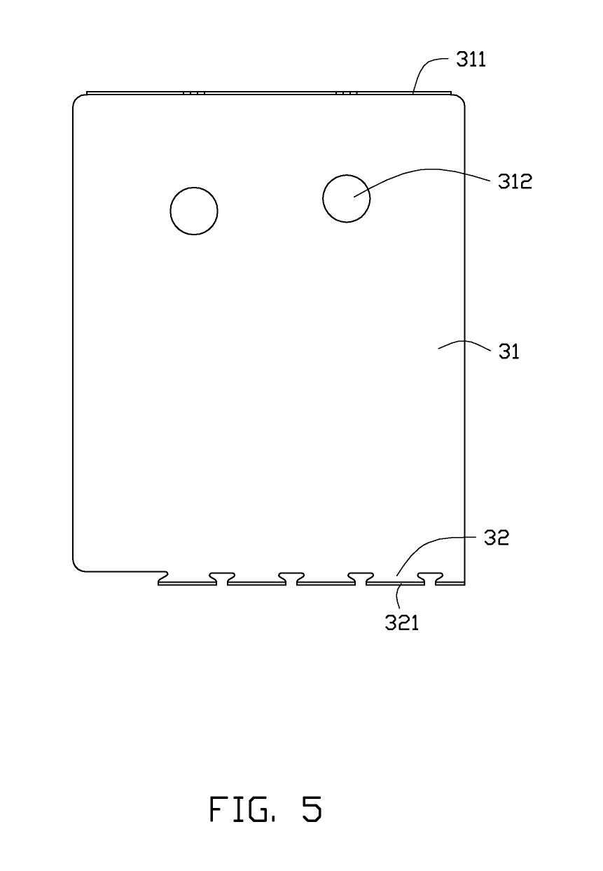

Referring to FIG. 5 also, the fin set 30 includes a plurality of fins 31 stacked together. Each fin 31 is parallel to and spaced from a neighboring fin 31, and perpendicular with the top surface 21 of the base 20. The fin 31 is rectangle-shaped. A first flange 311 bents horizontally from a top edge of the fin 31. Each first flange 311 is abutted against the first flange 311 of a neighboring fin 31, and a passage (not labeled) is defined between each two neighboring fins 31 for airflow flowing through. Each fin 31 defines two through holes 312 at a top portion for condensation sections 41 of heat pipe 40 extending through. Each through hole 312 defines a sleeve 313 bents horizontally at opening thereof. A plurality of tenons 32 are formed at a bottom portion of each fin 31. In the present embodiment, each tenon 32 is wedged. The tenon 32 has a configuration in complement with that of the recess 24. A second flange 321 bents horizontally from a bottom of each tenon 32. An extending direction of the second flange 321 is the same as that of the first flange 311. An extending length of the first flange 311 and the second flange 321 is equal to or less than a distance between two neighboring fins 31. Each second flange 321 abuts against a bottom of the recess 24. In the present embodiment, each tenon 32 of fin 31 has an interferential match with the corresponding recess 24 of the base to fix the fin 31 on the base 20.

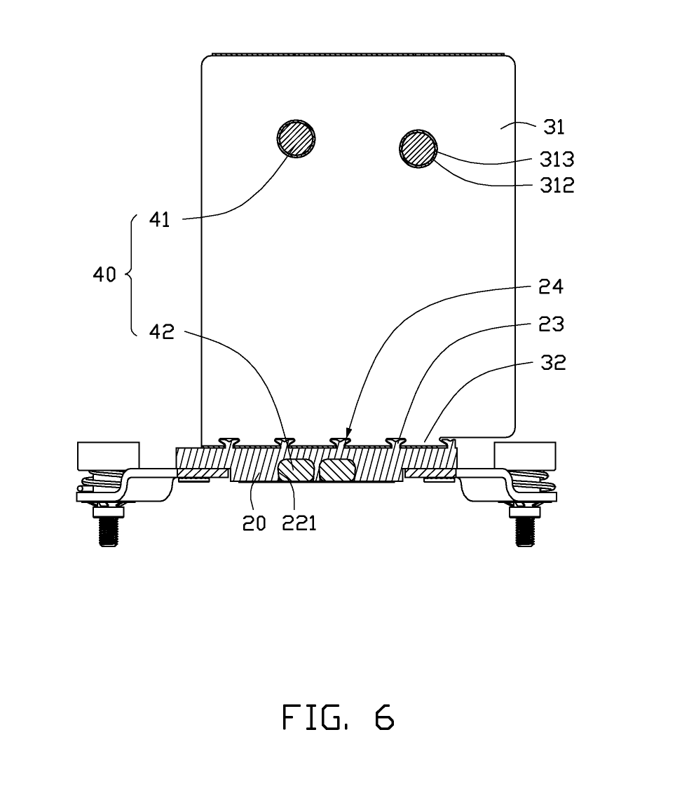

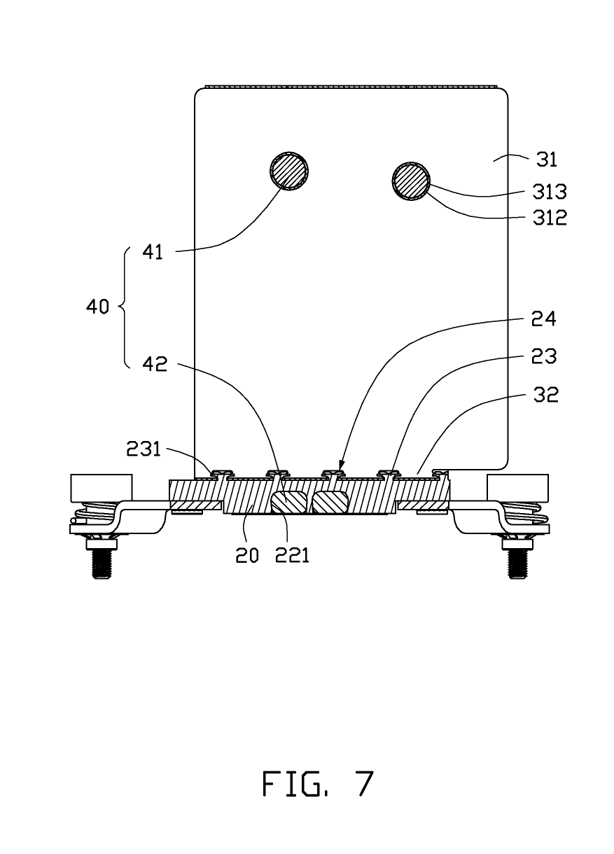

Referring to FIGS. 6 and 7 also, in assembly, the tenons 32 of each the fin 31 are received in the recesses 24 of the base 20, respectively, and the fins 31 engage with the base 20 one by one. Punching a part of each latch part 23 located between two neighboring fins 31 downward to the bottom surface 22 of the base 20 to make the part of the each latch part 23 distort into a substantial T-shape. In other words, a part of the V-shaped latch portion 231 is punched and distorted to flat, and a width of the distorted latch portion 231 is larger than that of the original latch portion 231; therefore, the fin 31 is firmly secured in the recesses 24 of the base 20 via every two T-shaped latch parts 23 located at two lateral sides of the fin 31, and the fin 31 cannot move along an extending direction of the condensation sections 41. It is understood that the part of each latch part 23 not be punched, which locates between neighboring tenons 32 of the fin 31, still presents as its original shape. And then, the evaporation sections 42 of the heat pipes 40 respectively extend through the grooves 221 of the base 20, and the condensation section 41 of the heat pipe 40 respectively extend through the through holes 312 of the fins 31. Pressing the evaporation sections 42 of the heat pipes 40 via a punch; therefore, each the evaporation section 42 has a configuration in complement with that of the corresponding groove 221, a bottom surface of the evaporation section 42 is coplanar to the bottom surface 22 of the base, and the evaporation section 42 interferentially fits with the corresponding groove 221. At last, the sleeve 313 of the corresponding through hole 312 is punched to make the condensation section 41 of the heat pipe 40 fix on the fins 31. In other embodiments, a single fin 31 engages with the base 20, the part of the latch part 23 which is neighboring the fins 31 is punched to be T-shaped, and then another fin 31 is installed via repeating the above processes.

The fin set 30 is firmly secured on the base 20 via every two T-shaped latch part 23 located at two lateral sides of each fin 31, and the heat pipe 40 has a firmly interferential match with the fin set 30 and the base 20. Compared with the conventional heat dissipation device, the present disclosure omits the process of soldering the base 20, the fin set 30 and the heat pipe 30 together, and the heat dissipation device 100 still has high heat dissipation efficiency, a simple structure, an easy operation, and a lower cost.

Referring to FIGS. 1-6, a method for assembling the heat dissipation device 100 in accordance with an exemplary embodiment is also disclosed. The method includes the following steps.

Step 1: a plurality of fins 31 is provided. A plurality of tenons 32 are formed at a bottom portion of each fin 31. Each tenon 32 is wedged.

Step 2: a base 20 is provided. A plurality of latch part 23 project from a top surface 21 of the base 20 and extend along a lengthwise direction of the base 20. A recess 24 is defined between two neighboring latch parts 23. Each latch part 23 includes a latch portion 231 and a supporting portion 232 connected to the latch portion 231 and the top surface 21 of the base 20. In the present embodiment, a cross section of the latch part 23 is Y-shaped, and a cross section of the latch portion 231 is V-shaped. The recess 24 has a configuration in complement with that of the tenon 32.

Step 3: the tenons 32 of each fin 31 are received in the recesses 24 of the base 20, and the fins 31 engage with the base 20 one by one.

Step 4: a part of each latch part 23 located between two neighboring fins 31 are punched downward to a bottom surface 22 of the base 20 to make the part of the each latch part 23 distorted into a T-shape. In other words, the V-shaped latch portion 231 of the each latch part 23 between two neighboring fins 31 is distorted to form a T-shaped latch portion 231, whereby the distorted part of latch portion 231 is flat, and a width of the distorted part of latch portion 231 is larger than that of the original latch portion 231. Therefore, the fin 31 is firmly secured on the recesses 24 of the base 20 via the two T-shaped latch part 23 located at two lateral sides of the fin 31.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A heat dissipation device comprising:
a base comprising two latch parts projecting from a top surface thereof, the two latch parts cooperatively defining a recess therebetween; and
a plurality of fins each defining a tenon at a bottom portion thereof, the tenon having a configuration in match with that of the recess, the latch parts located between two neighboring fins being punched to make the fins fix on the base.

2. The heat dissipation device of claim 1, wherein each latch part comprises a latch portion, and the latch portion has a V-shaped cross section before punching.

3. The heat dissipation device of claim 2, wherein the latch portion of the latch part located between two neighboring fins is punched and distorted to flat.

4. The heat dissipation device of claim 1, wherein the latch part comprises a latch portion and a supporting portion connected to the latch portion and the top surface of the base.

5. The heat dissipation device of claim 1, wherein the latch part has a Y-shaped cross section before punching.

6. The heat dissipation device of claim 5, wherein the latch portion of the latch part is punched and distorted to be T-shaped.

7. The heat dissipation device of claim 1, wherein the latch part is integrally formed with the base as a single piece.

8. The heat dissipation device of claim 1, wherein a flange bends horizontally from a bottom of each tenon, and each flange abuts against a bottom of the recess.

9. The heat dissipation device of claim 1, wherein the latch part extends longitudinally along the base.

10. The heat dissipation device of claim 1, further comprising a heat pipe, wherein the heat pipe comprises an evaporation section and a condensation section connecting with the evaporation section, a bottom surface of the base defines a groove for receiving the evaporation section of the heat pipe, and the condensation section of the heat pipe extends through the fins.

11. A method for assembling a heat dissipation device, comprising:
providing a plurality of fins, each fin defining a plurality of wedged tenons at a bottom portion thereof;
providing a base, a plurality of latch part projecting from a top surface of the base, a recess being defined between every two neighboring latch parts, each recess having a configuration in match with that of the corresponding tenon;
receiving the tenons of each fin in the recess of the base; and
punching the latch part located between two neighboring fins to make the fins fix on the base.

12. The method of claim 11, wherein each latch part comprises a latch portion, and the latch portion has a V-shaped cross section before punching.

13. The method of claim 12, wherein the latch portion of the latch part located between two neighboring fins is punched and distorted to flat.

14. The method of claim 11, wherein the latch part comprises a latch portion and a supporting portion connected to the latch portion and the top surface of the base, and the latch part has a Y-shaped cross section before punching.

15. The method of claim 14, wherein the latch portion of the latch part located between two neighboring fins is punched and distorted to be T-shaped.

16. A heat dissipation device comprising:
a base, a plurality of latch parts projecting from a top surface of the base, a recess being defined between every two neighboring latch parts; and
a plurality of fins, each fin defining a plurality of tenons at a bottom portion, each tenon engaging with a corresponding recess, the latch parts located between two neighboring fins being punched to make the fins fix on the base.

17. The heat dissipation device of claim 16, wherein each latch part comprises a latch portion, and the latch portion has a V-shaped cross section before punching.

18. The heat dissipation device of claim 17, wherein the latch portion of the latch part located between two neighboring fins is punched and distorted to be planar.

19. The heat dissipation device of claim 16, wherein the latch part comprises a latch portion and a supporting portion connected to the latch portion and the top surface of the base, and the latch part has a Y-shaped cross section before punching.

20. The heat dissipation device of claim 19, wherein the latch portion of the latch part located between two neighboring fins is punched and distorted to be T-shaped.
